(19) United States
(12) Patent Application Publication
(10) Pub. No.: US 2010/0058464 A1
(43) Pub. Date: Mar. 4, 2010

(54) Implementing a Process-Based Protection System in a User-Based Protection Environment in a Computing Device

(76) Inventors: Andrew Harker, Herts (GB); Matthew Allen, Essex (GB)

Correspondence Address: Saul Ewing LLP (Philadelphia), Attn: Patent Docket Clerk, 2 North Second St., Harrisburg, PA, 17101, US

(21) Appl. No.: 12/304,859

(22) PCT Filed: Jun. 14, 2007
(86) PCT No.: PCT/GB2007/002241

§ 371 Date: Mar. 6, 2009

(30) Foreign Application Priority Data
Jun. 15, 2006 (GB) 0611901.0

(51) Int. Cl. G06F 21/00

(52) U.S. Cl. 726/21

(57) ABSTRACT

A computing device having a security model based on user permissions is provided with an ability to emulate a security model based on process capabilities by providing each executable program on the device with a separate user identity.

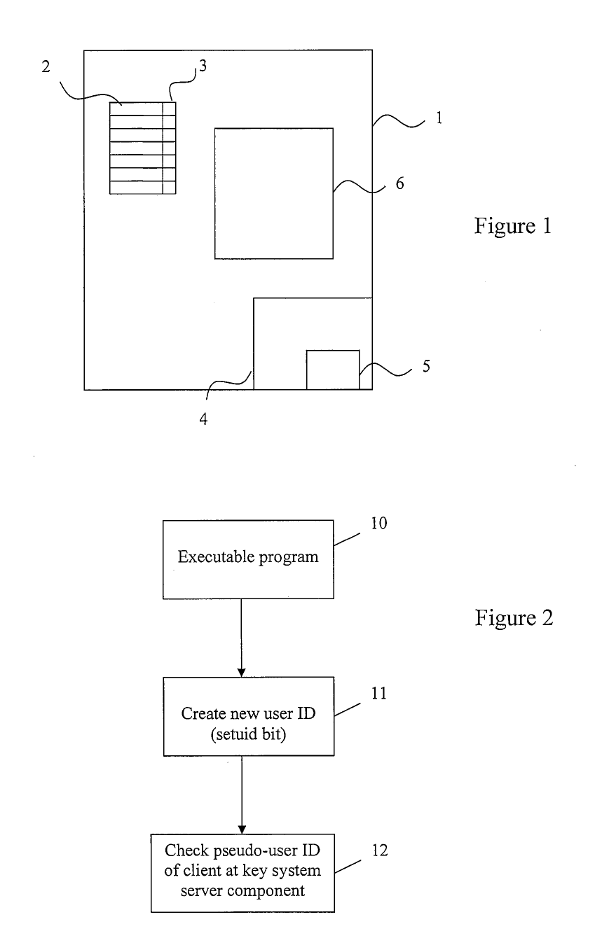

This invention relates to a method for implementing a process-based protection system in a user-based protection environment in a computing device and in particular to a method of improving the security available to single user computing devices running multi user operating systems such as Unix and its derivatives which employ a protection model based on user permissions.

The term computing device includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of such devices, together with many other industrial and domestic electronic appliances.

Computing device which allow their owners or users to install software subsequent to purchase, which makes available new applications or provides new functionality, are termed open devices. Computing devices that allow their owners or users to communicate with other computing devices for the exchange of data and instructions are termed connected devices.

Though there are clear benefits to being able to extend the utility of a device in these ways, the facilities to add extra software and to communicate with other machines can represent a significant security risk for the owner or user. Those skilled in the art, as well as many who are not so skilled, are aware that there is a significant risk that either badly written or malicious programs (ma/ware) can affect either open or connected computing devices; many devices available today are both open and connected, which multiplies their risks considerably. In the case of connected devices that are attached to other devices over a network, the risk can extend to all other devices connected to the network, and hence threatens the integrity of the network itself. There are many varieties of such malware; common types include, without being limited to, viruses, trojans, spyware and adware.

It is known that capability-based security systems offer significant benefits in terms of protection from malware for all computing devices, but especially to single user mobile open connected devices such as cellular telephones and PDAs. Capability based systems have been disclosed in a number of GB patent applications submitted by Symbian Software Ltd of London, UK, the manufacturer of Symbian OS™, the advanced operating system for mobile telephones and other connected devices. Of particular interest in this respect are GB2389747 entitled ‘Secure Mobile Wireless Device’ and GB2391655 entitled ‘Mobile Wireless Device With Protected File System’.

In the capability protection model as described in GB2389747, executable programs are granted certain privileges which, when taken together, define what areas of functionality each executable program is able to access. For instance, a program without network capability is prohibited from initiating network connections to other computers. A range of similar capabilities controls access to various other aspects of the functionality of the device in question. Capabilities can only be granted to executables when they are first compiled and built, and they cannot be added to; a system of testing and certification controls the capabilities granted to executables. Certain very sensitive capabilities (such as those that control the ability to format a disk, for example) are only granted to those executable code components that are part of the Trusted Computing Base {TCB} at the core of the operating system of the device.

An additional feature available to devices which implement capability-based protection is disclosed in GB239165. This document describes how executables programs installed on the device do not have unrestricted visibility of the entire file system on the device. They are provided with their own private or restricted area within the entire file system, where all their data files are stored, and to which no other applications have access. Furthermore, apart from certain common areas of the file system to which access is unrestricted, these executable programs have no visibility of any other parts of the file system. In particular, they have no visibility of the private areas of any other application. This feature is known as data caging, because applications are effectively caged in their own file system area; this restriction is enforced by the operating system which controls the device.

However, capability based security systems are not the only available methods for protecting computing devices from attack. A capability based system associates protection with programs, but there are alternative models which associate protection with different entities. The most notable alternative model, which originated in the multi-user computer world, associates protection with the user of the device rather than with the data or the program. Under this model, different users cannot normally see other users' data; and some abilities on the system are associated with particular classes of user, such as administrators, who are granted special system permissions.

One notable example of a user permission based protection system is Unix and its derivatives (including Linux). They offer the ability to select which user's protection domain should be associated with a given program.

There is a clear difference between protection systems based on system-wide capabilities and those based on user permission. With a capability model, a malicious executable would never be granted the capabilities to access any functionality that is sensitive or potentially destructive, and without being granted such capabilities, its capacity to do harm is extremely restricted.

On the other hand. a malicious executable running on a device with a model based on user permissions would inherit whatever permissions that the user running it had been granted. If the user had administrator-level privileges and had access to every part of the file system and every peripheral and subsystem on the device, any malware run under that administrator used permission would be able to do significant damage.

Especially on single-user devices, security models based on user permissions provide no significant additional functionality but present significantly greater operating risks when compared to protection systems based on capabilities.

However, when integrating software from different environments subscribing to different protection models, it can be difficult to reconcile any software that expects program-based protection such as is provided by the capability model with a software environment where protection is based on user permissions.

In fact, no prior art to facilitate the integration of the two protection models is known. Current practice is to convert software from one protection system to another, rather than providing a system-wide solution which enables it to run unchanged.

According to a first aspect of the present invention there is provided a method of operating a computing device having a security model based on user permissions, the method comprising enabling the computing device to emulate a capability based security model by providing each executable program on the device with a separate user identity.

According to a second aspect of the present invention there is provided a computing device arranged to operate in accordance with a method of the first aspect.

According to a third aspect of the present invention there is provided an operating system for causing a computing device to operate in accordance with a method of the first aspect.

Embodiments of the present invention will now be described, by way of further example only.

This invention discloses a method of mapping the data caging features of a capability protection model, such as that disclosed in GB2391655 on to a user permissions capability model, such as that available in versions of Unix and its derivatives, such as Linux.

This is achieved by automatically creating a new pseudo-user for each and every installed program on a computing device, such that each program which is run on that device does so as the pseudo-user that was created for that program. The mechanism for doing this is preferably provided by the Unix setuid bit, which enables the user ID of a running process to be altered to match the user ID of the owner of an executable program file.

On Unix systems, users (including pseudo-users) can have their own different private areas of the file system, in the same way that executable programs do on a device that implements GB2391655, referred to above. Therefore, providing each installed program with a unique pseudo-user identity effectively provides a workable emulation of per-program data-caging by giving each executable program its own file area.

Policing of this method can be achieved by ensuring that key system server components (such as the main file server) check the pseudo-user identity of their clients.

The initial identity of the pseudo-user may be determined at install time (e.g. by using the next free identity in some logical sequence of names or numbers) or it may be determined before install time, either by including the identity in the program file or the installable package, or by a separate means.

Where the underlying user permission protection model allows users to be associated with distinct groups and further supports the ability for certain executables to run only if they are members of a particular group or set of groups, a scheme of pseudo-user identities can be used to map schemes of program-based trust settings such as capabilities as described in GB2389747. The Unix setgid bit can be used for this purpose.

Therefore, it can be seen that this invention practically extends the benefits of capability-based protection schemes to those protection schemes that natively implement protection schemes based on user permissions without the necessity of complicated re-engineering. It is of particular utility in the context of devices which are inherently single user but which are running operating system software designed for a multi-user computer system. Advanced mobile telephones and smartphones running Linux are good examples of this type of computing device.

The invention is considered, therefore, to solve a difficult technical problem by using existing security infrastructure tools in a novel way.

Although the present invention has been described with reference to particular embodiments, it will be appreciated that modifications may be effected whilst remaining within the scope of the present invention as defined by the appended claims.

1. A method of operating a computing device having a security model based on user permissions, the method comprising enabling the computing device to emulate a capability based security model by providing each executable program on the device with a separate user identity.

2. A method according to claim 1 wherein the user identity given to an executable program is either
a. determined at install time, by means including but not limited to the use of the next free identity in a sequence; or
b. determined before install time, by means including but not limited to the inclusion of the identity in the program package to be installed.

3. A method according to claim 1 wherein each user identity confers an ability to access a private file storage area reserved for that user identity.

4. A method according to claim 1 wherein user identities are collected into group identities, which may not be mutually exclusive, and in which membership of any group confers an ability to access system resources denied to user identities that are not members of that group.

5. A method according to claim 1 wherein the computing device comprises a Unix operating system or a related operating system, and wherein the setuid and setgid bits of an executable program are used to enable a process to adopt the user and group identities for that program.

6. A computing device arranged to operate in accordance with a method as claimed in claim 1.

7. An operating system for causing a computing device to operate in accordance with a method as claimed in claim 1.
